(19) United States
(12) Patent Application Publication
(10) Pub. No.: US 2019/0249354 A1
(43) Pub. Date: Aug. 15, 2019

(54) STAIN REMOVAL ACCESSORY

(71) Applicant: KONINKLIJKE PHILIPS N.V., Eindhoven (NL)

(72) Inventors: KANNAN UDAYAPPAN PRAVEEN, EINDHOVEN (NL); YILE LIAO, EINDHOVEN (NL); SHENGHUAI CALVIN LIN, EINDHOVEN (NL); CHIEN-PING ADRIAN KOH, EINDHOVEN (NL); LIHONG ZHAO, EINDHOVEN (NL); YONG JIANG, EINDHOVEN (NL)

(21) Appl. No.: 16/093,191

(22) PCT Filed: Oct. 31, 2017
(86) PCT No.: PCT/EP2017/077902

§ 371 Date: Oct. 12, 2018

(30) Foreign Application Priority Data
Nov. 1, 2016 (EP) 16196680.9
Aug. 7, 2017 (EP) 17185094.4

(51) Int. Cl. D06F 43/00; A47L 25/08; C11D 11/00; C11D 17/04; D06F 87/00; D06F 39/04; D06F 39/12

(52) U.S. Cl. CPC D06F 43/002; A47L 25/08; C11D 11/0017; D06F 39/12; D06F 87/00; D06F 39/04; C11D 17/041

(57) ABSTRACT

Stain removal accessory (171) intended to cooperate with a stain removal device (1) for treating a stained area, the stain removal accessory (171) is attached to the front head of the stain removal device (1), namely to the water and/or steam venting face of said stain removal device (1), and comprises a container (400) like a pad, a cartridge, a sachet or a capsule provided with a permeable external layer, for containing a stain removing material (300), and a holder (600) for holding said container (400), whereby said stain removal accessory (171) is adapted to release said stain removing material (300) on the stained area when cooperating with the stain removal device (1) by facing the flow of water and/or steam (200) generated by said stain removal device (1).

### FIELD OF THE INVENTION

The present invention relates to the field of stain removal.

### BACKGROUND OF THE INVENTION

Treating stain on garments via chemical is known, such as using a portable stick accessory containing a tank filled-in with chemical to be spread on the garment by user.

Those known solutions often imply the need to fill-in a container with liquid bleach chemical, which is not convenient for user, and involves some risks.

### SUMMARY OF THE INVENTION

It is an object of the invention to propose a stain removal accessory that avoids or mitigates above-mentioned problems.

The invention is defined by the independent claims. The dependent claims define advantageous embodiments.

To this end, the stain removal accessory according to the invention comprises:
a container for containing a stain removing material,
a holder for holding the container,

The stain removal accessory is adapted to release said stain removing material on the stained area when cooperating with the stain removal device.

This solution allows a convenient and efficient stain removal, because the bleach chemical is already included in the stain removal accessory. In other words, the user only need to manipulate the stain removal accessory, which is convenient and safe.

The invention also relates to a stain removal device comprising means to cooperate with a stain removal accessory as described above.

The invention also relates a method of treating a stain on a garment by a stain removal device as mentioned above, using a stain removal accessory as mentioned above.

Detailed explanations and other aspects of the invention will be given below.

### BRIEF DESCRIPTION OF THE DRAWINGS

These and other aspects of the invention will be apparent from and elucidated with reference to the embodiment(s) described hereinafter. In the following drawings

FIG. 1A is a schematic side view of the stain removal device 1 cooperating with a stain removal accessory 171 according to the invention,

FIG. 1B are internal schematic views of the stain removal device 1 and the stain removal accessory 171 according to the invention,

FIG. 13 are various schematic perspective views of a stain removal device according to an embodiment of the present invention,

FIG. 14 shows the chemical formation of H₂O₂ from sodium percarbonate,

FIG. 15 shows the chemical formation of peroxy acid from TAED,

FIG. 16 shows the chemical formation of peroxy acid from DOBA,

FIGS. 18A to 18F is a set of schematic usage illustrations of the stain removal device with a stain removal accessory according to the invention,

FIG. 19 and FIG. 20 depict another embodiment of a stain removal accessory according to the invention,

FIG. 21 depicts the stain removal accessory according to an embodiment of the present invention in two different positions,

FIG. 22, FIG. 23 and FIG. 24 depict illustrations of an alternative embodiment of a stain removal accessory according to an embodiment of the present invention,

FIG. 35 depicts different views of another embodiment of a stain removal accessory according to the invention,

FIG. 36 depicts a stain removal accessory according to the invention when cooperating with the front head of a stain removal device, during the step of stain removing,

FIG. 37 depicts a stain removal accessory according to the invention when cooperating with the front head of a stain removal device during the step of rinsing the stained area,

FIG. 38 depicts a stain removal accessory according to the invention when cooperating with a stain removal device 1 during the step of stain removing,

FIG. 39 depicts a stain removal accessory according to the invention when cooperating with a stain removal device during the step of rinsing (and drying),

FIG. 40 depicts a stain removal accessory according to the invention implementing a container comprising a plurality of sub-compartments, each sub-compartment comprising a stain removing material,

FIG. 41 depicts a flow chart of a method according to the invention of treating a stain on a garment.

### DETAILED DESCRIPTION OF THE EMBODIMENTS

The stain removal accessory according to the invention is intended to cooperate with a stain removal device for treating a stained area. The stain removal device is adapted to treat stain spots on garments locally without the need of washing the whole garment. The stain removal device may have any combination of integrated functions of the following steps:
1) stain removing by using water and/or steam applied to a stain removal material contained into the stain removal accessory,
2) rinsing off the stain residues and chemical residues,
3) evaporating water from the treated area of the garment.

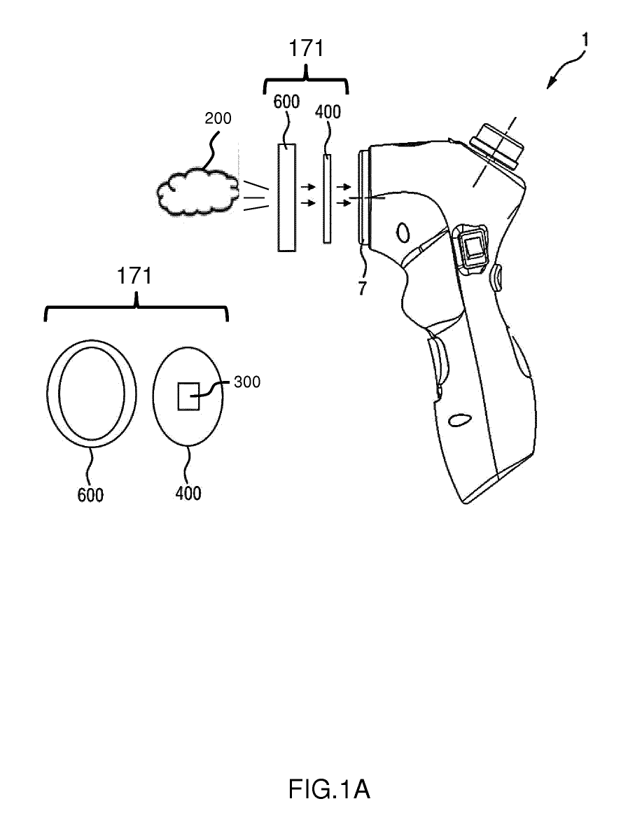

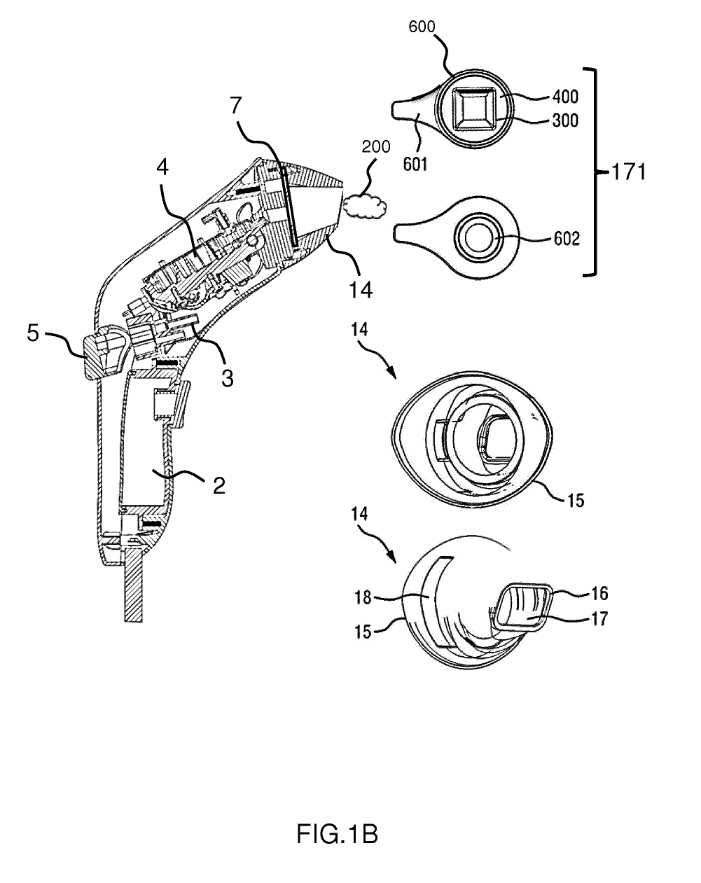

FIG. 1A is a schematic side view of the stain removal device 1 cooperating with a stain removal accessory 171 according to the invention.

In the present context, it is noted that the stain removal accessory according to the invention can also be called a “chemical bleach applicator”.

The stain removal accessory 171 comprises:
a container 400 for containing a stain removing material 300.
a holder 600 for holding the container 400.

It is noted that the holder 600 can also be called a “frame”.

The stain removal accessory 171 is adapted to release the stain removing material 300 on the stained area when cooperating with the stain removal device.

Preferably, the container 400 is disposable.

The stain removing material 300 corresponds to bleach chemical. Most of stain removing material 300 (Sodium percarbonate, TAED, DOBA, NOBS, etc) used in a laundry cleaning or dish washer products are in solid form (e.g. powder, granule). The stain removing material 300 requires to be dissolved in fluid 200 generated by device 1 in order to release H₂O₂ or peroxy acid. In particular, fluid 200 corresponds to water and/or steam. H₂O₂ or peroxy acid kills bacteria and removes stains on a material like fabric, glass, or plastic by oxidizing the stain molecules from colored structure to colorless structure.

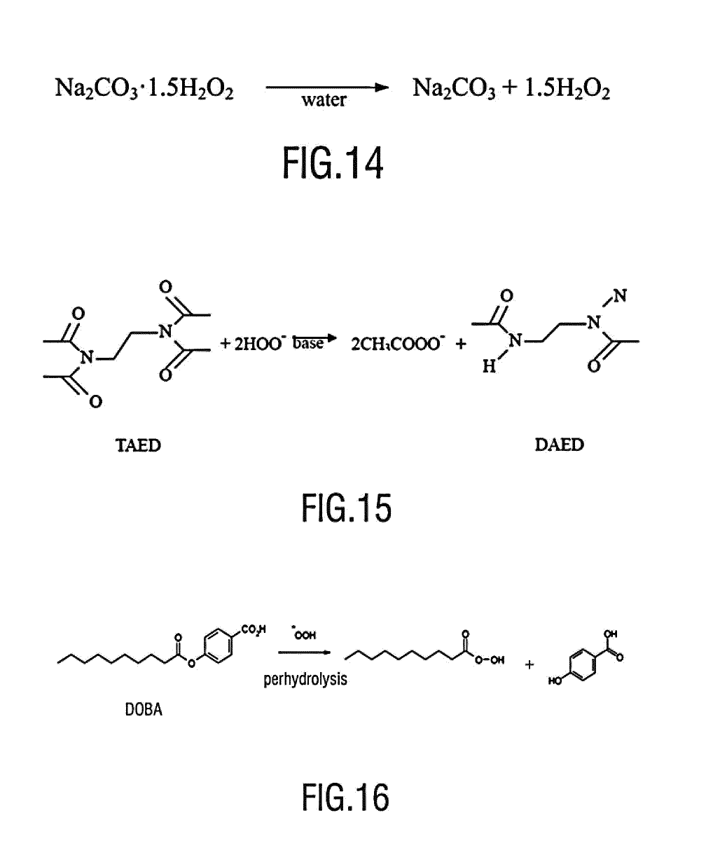

FIG. 14 shows the chemical formation of H₂O₂ from sodium percarbonate.

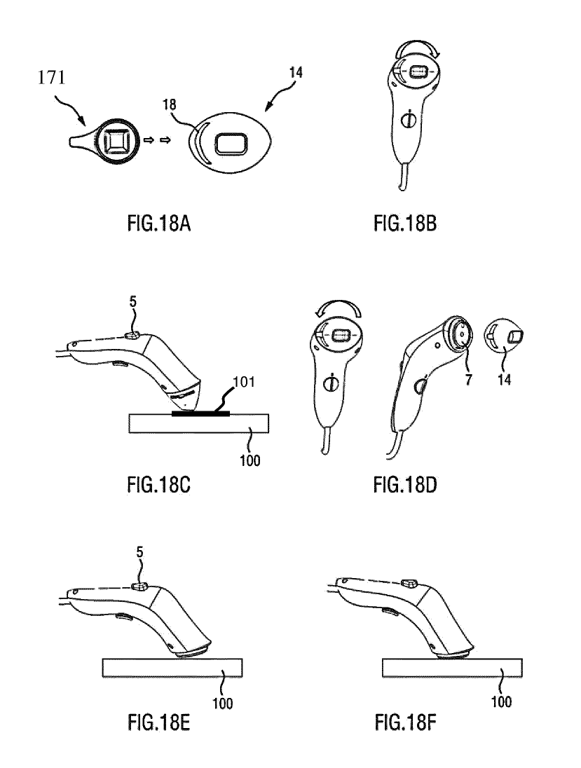

FIG. 15 shows the chemical formation of peroxy acid from TAED.

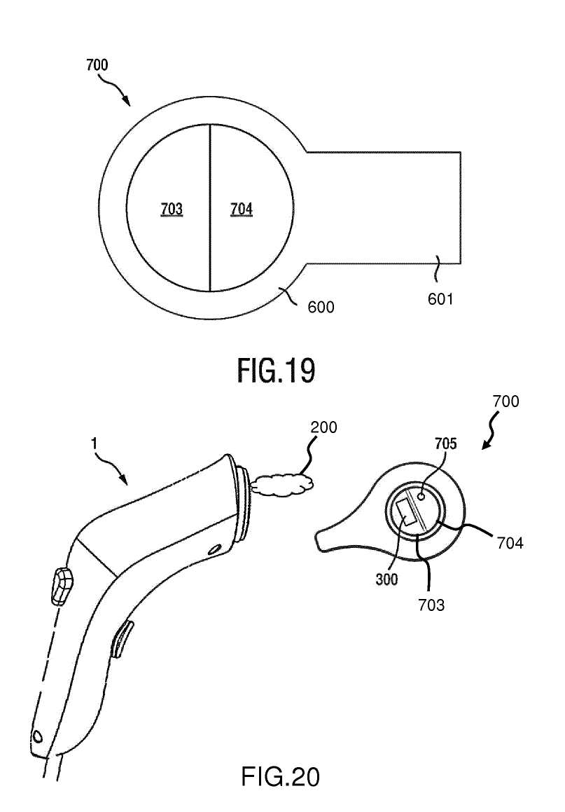

FIG. 16 shows the chemical formation of peroxy acid from DOBA.

The stain removing material 300 may contain:
Active oxygen sources, e.g. hydrogen peroxides (H₂O₂); Sodium percarbonate (Na₂CO₃.1.5H₂O₂); sodium perborate (NaBO₃.H₂O, or NaBO₃.4H₂O), etc. and
Preferably also any one of the following bleach activator (taken alone or in combination):
   tetraacetylethylenediamine (TAED),
   4-decanoyloxybenzoic acid (DOBA),
   sodium salt of nonanoyloxybenzenesulphonic acid (NOBS),
   sodium salt of 3,5,5-trimethylhexanoyloxyphenylsulfonic acid (iso-NOBS),
   sodium salt of acetoxyphenylsulfonate,
   sodium decanoyloxybenzene sulfonic acid (DOBS),
   sodium octanoyloxybenzene sulfonic acid (GOBS),
   GOBS,
   sodium nonanoyloxybenzoic acid (NOBA),
   N,N-Diacetylethylenediamine,
   N-[4-(triethylammoniomethyl) benzoyl]butyrolactamchloride (TBBC), sodium trimethylhexanoyloxybenzenesulfonate (STHOBS),
   sodium-4-benzoyloxybenzenesulfonate (SBOBS),
   glucose pentaacetate (GPA),
   tetraacetylglucoluril (TAGU),
   nitrilotriacetate (NTA),
   transition metal bleach catalyst etc.

The stain removing material 300 is a chemical reagent in solid form (powder, granule), or in liquid form (in this case the liquid is held in a wet tissue, sponge . . . etc).

Preferably, the container 400 takes any of the forms defined by a bag, a pad, a cartridge, a sachet, and a capsule. The container 400 may looks like a “tea bag” with fluid-permeable external layer, for example made of density paper, fabric, non-woven fabric, porous plastic, etc.

The stain removal accessory 171 is adapted to release the stain removing material 300 on the stained area 101 when cooperating with the stain removal device 1.

Preferably, as illustrated, the holder 600 comprises a frame structure arranged at least partly around the container 400. For example, the frame structure can be circular, elliptic, arc-shaped, triangular, rectangular, square, semi-circular or semi-elliptic.

The right-side view of FIG. 1A shows an exploded view of the mounting of the stain removal accessory 171 when cooperating with device 1.

The stain removal accessory 171 can be mounted onto the steam venting face (sometimes combined with the heating plate together) of the device 1. Device 1 may correspond to a steam generation device, for example a garment steamer.

FIG. 1B are internal schematic views of the stain removal device 1 and the stain removal accessory 171 according to the invention.

Preferably, a guide head 14 is further assembled to the holder 600. Alternatively, the guide head 14 is assembled to the front side of the device 1, while the guide head 14 enclosing the stain removal accessory 171. The guide head 14 may comprise a back end interface 15 and a front end interface 16. The back end interface 15 receives the fluid 200 generated by the device 1. The front end interface 16 gathers the fluid 200 into a spout 17 facing the stained area on a fabric.

A liquid tank 2 supplies water to a dispensing mechanism 3, for example a pump. The dispensing mechanism 3 supplies water 200 to a steam engine 4. A pressing trigger 5 allows activating the dispensing mechanism 3. The steam engine 4 supplies steam 200 to the guide head 14. The heating plate 7 is in thermal connection the steam engine 4, so that the heating plate 7 can be heated.

In a first working mechanism, the fluid 200 generated by the device 1 is steam and passes through the container 400. The bleach solid 300 inside the container 400 is then dissolved by the steam condensation and carried out onto the stained area.

In a second working mechanism, the container 400 is used with (hot) water 200 generated by the stain remover device 1. To this end, water from the water tank 2 is carried by an additional pump (not shown) to the front head of the device 1. A heating element (not shown) is implemented if hot water is intended to be generated. The (hot) water/steam 200 passing through the container 400, and carries out the dissolved bleach solution 300 onto the stained area.

In a third working mechanism, if the stain removing material 300 is under liquid form in the container 400, there is no need for the device 1 to provide water and/or steam. The front head of the device 1 holding the stain removal accessory 171 is directly applied on the stained area.

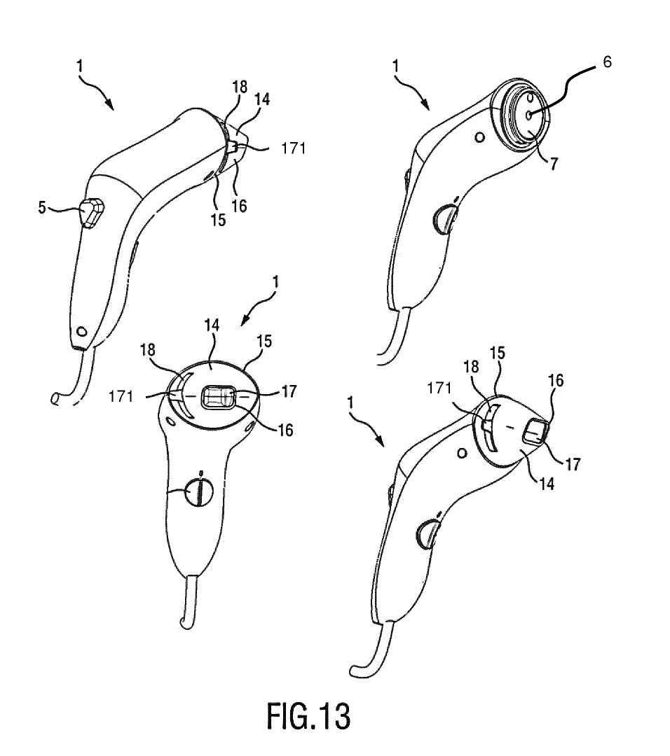

FIG. 13 shows various schematic perspective views of a stain removal device 1 using a guide head 14 for treating the stain on a fabric according to the present invention.

The opening 6 on the heating plate 7 is sized to enable the outgoing steam 200 to have a certain velocity. This velocity is a function of the size of the opening and the steam rate. For a steam rate of 25 g/min, the optimal opening dimension is 6 mm in diameter. This combination gives a good steam rate and velocity to enhance the rinsing because the velocity creates a pressure difference between the treatment side and underside of the fabric 100. The pressure difference pushes the fluid 200 through the fabric 100. The relatively low steam rate also enables longer operation without the need for a large liquid tank.

Optionally, the steam rate can be between 5 g/min and 150 g/min. The diameter of the opening 6 can be between 3 mm and 30 mm. The steam 200 can be pure dry steam 200 (commonly transparent and hard to be envisaged by naked eyes) or wet steam 200 (commonly white color). It was observed that wet steam 200 (steam with droplets of water) produced better rinsing results but wetter fabric 100.

Preferably, the holder 600 of the stain removal container comprises a hand grip 601 (also called a holding tab) allowing to easily inserting the holder 600 of the stain removal accessory 171 into the insert slot 18 of the stain removal device 1.

Furthermore, the holder 600 of the stain removal container 400 may comprise a rear 602 to create a thermal contact with the heating plate 7 when the holder 600 is attached to the device 1.

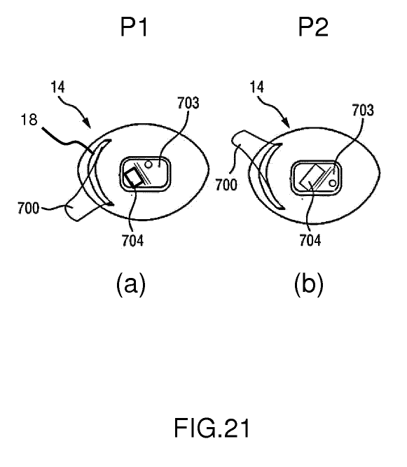

FIGS. 18A to 18F is a set of schematic usage illustrations of the stain removal device 1 with a stain removal accessory 171 according to the invention.

Device 1 comprises the guide head 14 attached to the steam venting face of the device 1, and with which the stain removal accessory 171 is intended to be cooperate, for example by inserting the stain removal accessory 171 in the slot 18 arranged in the guide head 14, as illustrated in FIG. 18A and FIG. 18B.

As most of bleach contents 300 (Sodium percarbonate, TAED, DOBA, NOBS, etc.) used in a laundry cleaning or dish washer product is in solid form (e.g. powder, granule), the bleach solid chemical contained in the container 400 requires to first be dissolved in water 200 in order to release H₂O₂ or peroxy acid. To this end, the stain removal accessory 171 is attached to the device 1 in order to release the dissolved bleach solution 300.

FIG. 18C shows the stain removing process.

The stain removing material 300 are cleaning agents that are pre-filled in the container 400. Once dissolved by water and/or steam, the stain removing material 300 are dispensed onto the stained area 101 of the fabric to react with, dissolve or cover the stain molecules. To this end, the front head of the device 1 can be brought into close contact with the stained area 101, as illustrated in FIG. 18C.

The device 1 may also provide heat to the stained area 101 in order to accelerate the chemical reaction, dissolving or covering rate. Heat sources include but are not limited to steam, conduction, infrared heat and microwaves. For example, a heating plate 7 can be used to generate heat by conduction.

In order to activate the stain treatment process, the rinsing pump is activated via the pressing trigger 5 (possibly repeatedly) so that water (and/or steam) can pass through the container 400.

FIG. 18E shows the rinsing process. The main objectives of this stain rinsing process are:

1) to stop the chemical reaction upon after the step of stain removing, so as to prevent further chemical reactions.

2) to remove the stain removing material and their by-products from the garment 100 to avoid possible irritation/allergic reactions when the garment is put on by user.

It is noted that in order to guarantee that the fluid 200 used for rinsing (i.e. water, steam, chemical neutralizer or a combination of all) is not contaminated by the chemicals remaining in the container 400, the stain removal accessory 171 (or at least the container 400) needs to be removed from device 1 before starting the rinsing step.

FIG. 18D shows the detachment of the stain removal accessory 171 and guide head 14 from the device 1. The stain removal accessory 171 can for example be attached/detached via a rotating movement.

The rinse process can be achieved by either neutralization of the bleach chemical or dilution of the bleach chemical. For the best rinsing result, these chemical residues should preferably be extracted from the fabric by an absorption means (for example a backing pad, a tissue, a towel . . . ) or by mechanical forces. The rinsing process is activated by the pressing trigger 5 (possibly repeatedly).

FIG. 18F shows the drying process.

Drying of the already rinsed fabric 100 relies on removal of the moisture on the fabric 100. The moisture can be evaporated through direct heating with the heating plate 7 (˜100-170° C.) or heated air 7 (˜60-100° C.).

In the following, solutions according to the invention will be disclosed with the goals of:

1. Saving the step of removing the stain removal accessory 171 (or the container 400 containing the stain removing material 300) before the step of rinsing.

2. Saving the space of placing the removed stain removal accessory 171 (or the container 400).

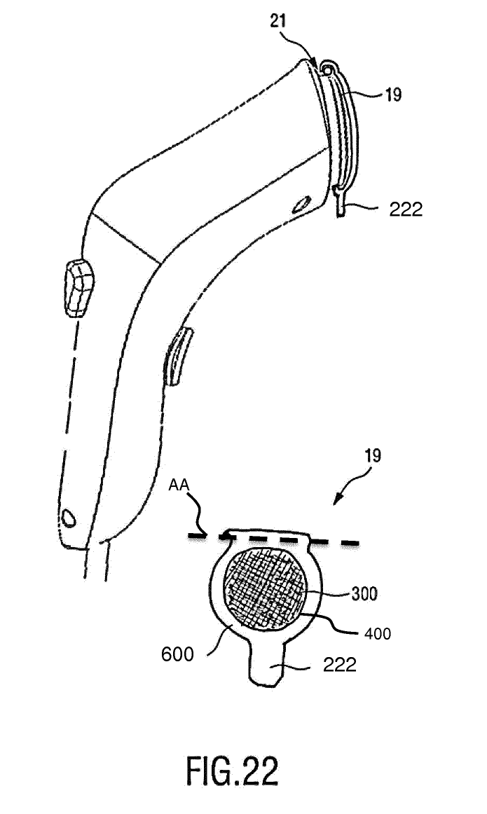

FIG. 19 and FIG. 20 depict another embodiment of a stain removal accessory 700 according to the invention.

Compared to the stain removal accessory 171 described above, the stain removal accessory 700 comprises at least two parts as follows:
a first part 703 for arranging the container 400 containing the stain removing material 300,
a second part 704 comprising a through hole 705.

The stain removal accessory is adapted to take a first position (P1) during a step of stain removing, and a second position (P2) during a step of rinsing the stained area.

The through hole 705 corresponds to an open fluid pathway.

For example, the through hole 705 is at an angular position different with respect to the angular position of the container. For example, the difference of the angular positions is 90 or 180 degrees.

The stain removal accessory 700 forms a pathway selector.

The working face of the stain removal accessory 700 is divided into at least two parts, the first part 703 is for storing the container 400 containing the stain removing material 300, the second part 704 is empty.

The stain removal accessory 700 also comprises a holder 600 with preferably a hand grip 601 for changing the position of the holder 600 compared to the device 1.

The holder 600 can be attached to the front head (having the steam venting face) of the stain remover device 1.

If container 400 containing the stain removing material 300 (i.e. cleaning reagent sachet/cartridge) is disposable, the container 400 is inserted into the first part 703 of the holder 600, while the second part 704 of the holder 600 is left empty. Alternatively, the second part 704 may contain a chemical neutralizer or fragrance agents (or vice versa) used during a step of rinsing the stained area.

The stain removal accessory 700 allows a selectable water pathway for stain treatment and rinsing when cooperating with a stain removal device.

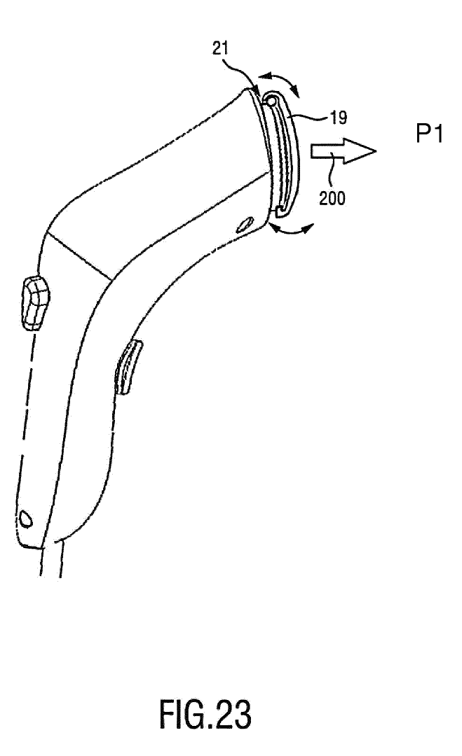

When the stain removal accessory 700 cooperates with stain remover device 1, the following happens:
Fluid such as water 200 passes through the container 400 during stain treatment process for dissolving the stain removing material 300 and carry the dissolved stain removing material 300 onto the stained area. In this step of stain removing, the stain removal accessory 700 is adapted to take a first position (P1) when cooperating with the stain removal device 1. This is illustrated by view (a) of FIG. 21.
Fluid like water 200 passes the through hole 705 during rinsing process. In this step of stained area rinsing, the stain removal accessory 700 is adapted to take a second position (P2) when cooperating with the stain removal device 1. This is illustrated by view (b) of FIG. 21.

Preferably, the stain removal accessory 700 is rotatable when mounted to the stain removal device 1. For example, the stain removal accessory 700 is rotatable in the slot 18 arranged in the guide head 14. Rotating the stain removal accessory 700 provides a first position during a step of stain removing in which the first part 703 faces the flow of water and/or steam 200 generated by device 1, and a second position during a step of rinsing the stained area in which the second part 704 faces the flow of water and/or steam 200 generated by device 1.

Thus, the device 1 can provide two different functions by turning the holder 600 in a first direction or turning the holder 600 in an opposite direction, for example via the hand grip 601.

Instead of a relative rotation movement between the stain removal accessory 700 and the stain removal device 1, other executions to change the fluid pathway between a stain removing step and a rinsing step can be considered, such as flipping and un-flipping the holder 600 as described in the following.

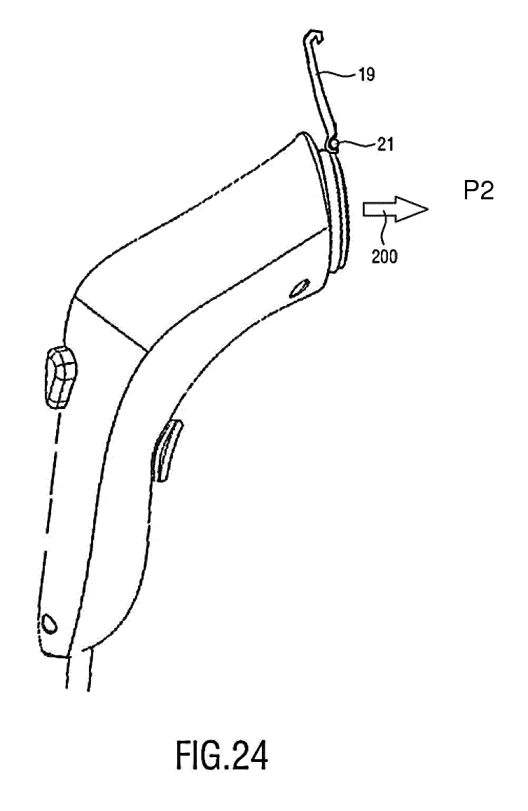

FIG. 22, FIG. 23 and FIG. 24 depict illustrations of an alternative embodiment of a stain removal accessory according to an embodiment of the present invention.

As illustrated in FIG. 22, the stain removal accessory defines a flap-flip piece 19 that can be mounted to the front head of device 1.

The flap-flip piece 19 is adapted to take a first position (P1) during a step of stain removing, and a second position (P2) during a step of rinsing.

The flap-flip piece 19 comprises a holder 600 which is attached to the steam-venting face of the stain removal device 1, for example by a hinge 21 rotating around an axis AA. The holder 600 is adapted to receive a container 400 containing a stain removing material 300 as described above, and is applied to produce the chemical reagent 300 with the help of the fluid (i.e. steam and/or water) 200 produced by the main body of the stain removal device 1 during the stain removing process.

The holder 600 may also comprise a hand grip 222 for easily changing the orientation of the holder 600 when the stain removal accessory 19 is mounted on the stain removal device 1.

FIG. 23 depicts the situation when the flap-flip piece 19 faces the front head of the stain removal device 1. In this position (P1), the water and/or steam generated by the device 1 passes through the container 400. This position corresponds to the step of stain removing.

FIG. 24 depicts a situation when the flap-flip piece 19 does not face the front head of the device 1. In this position (P2), the water and/or steam generated by the device 1 does not pass through the container 400, and can be directly applied to the stained area. This position corresponds to the step of rinsing.

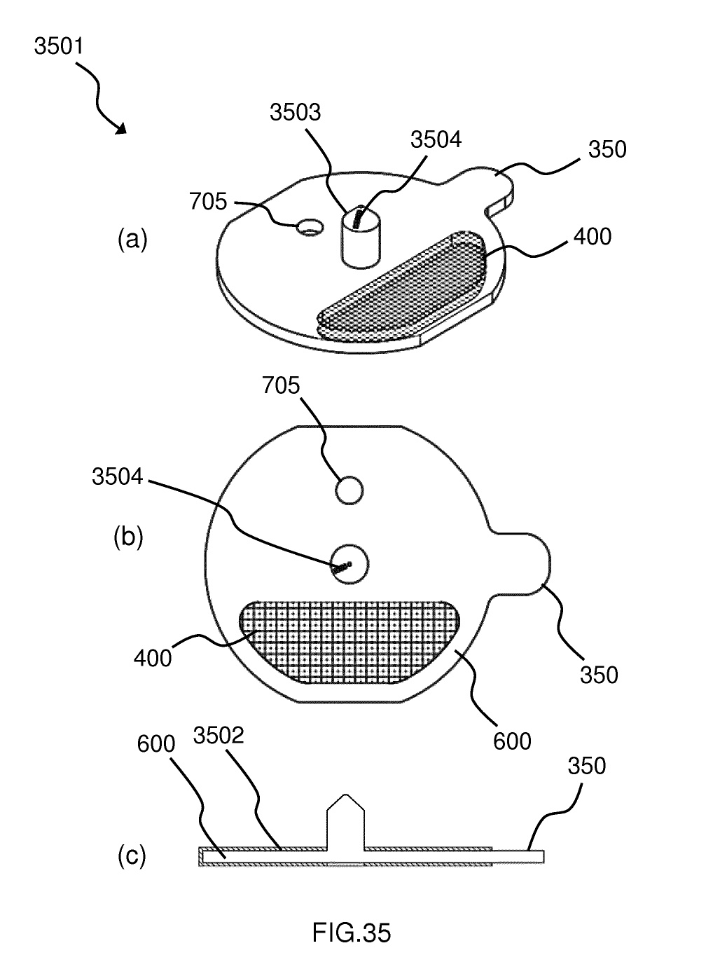

FIG. 35 depicts different views of another embodiment of a stain removal accessory 3501 according to the invention.

The view (a) corresponds to a three-dimensional view of the stain removal accessory 3501.

The view (b) corresponds to a top view of the stain removal accessory 3501.

The view (c) corresponds to a cross-section view of the stain removal accessory 3501.

The stain removal accessory 3501 is intended to cooperate with a stain removal device for treating a stain on a garment, such as a stain removal device 1 as described above.

The stain removal accessory comprises a holder 600 for holding a container 400 containing a stain removing material 300 as described above.

The container 400 is adapted to:
receive water from the stain removal device for dissolving the chemical agent, and
spreading the dissolved stain removing material over the stained area on the garment.

The stain removal accessory also comprises a through hole 705 for receiving water from the stain removal device during rinsing of the stain.

Preferably, the through hole 705 is at an angular position different with respect to the angular position of the container 400. For example, the difference of the angular positions is 90 or 180 degrees.

Preferably, the holder 600 is adapted to transfer heat from the stain removal device to the stained area.

For example, the holder 600 is made of a heat conductive/inductive material to allow the stain removal accessory to be heated up by the stain removal device and transfer heat to the stained area. For example, the heat conductive/inductive material takes the form of an outer layer 3502.

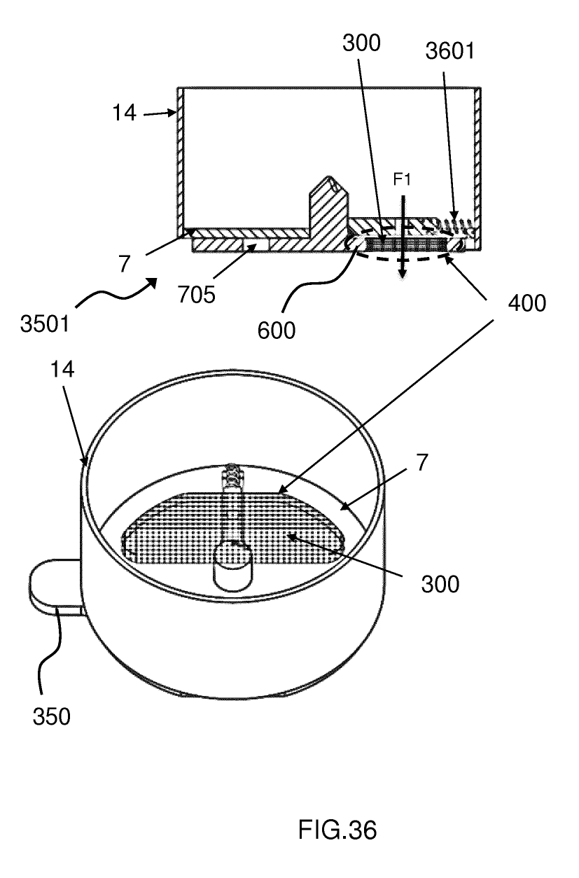

Preferably, the stain removal accessory further comprises a physical element 3503 to activate a water-flow switch 3601 in the stain removal device in order to open/close a water circuit. For example, the physical element 3503 may correspond to a protruding element. For example, the switch may correspond to a spring-loaded switch. The spring-loaded water-flow switch 3601 is illustrated in FIG. 36.

The water-flow switch is activated in either the steps of stain removing and rinsing, as those two steps require a flow of water.

Preferably, the stain removal accessory further comprises a capacitive and/or resistive element 3504 that can be detected by the stain removal device to turn-on the generation of heat on the stain removal device. For example, the generation of heat is performed by the heating plate arranged at the front head of the stain removal device.

Preferably, the stain removal accessory further comprises a hand grip 350, for example taking the form of an extended portion, used for inserting and rotating the stain removal accessory in the stain removal device.

The stain removal accessory 3501 can be disposable and designed for single use. In that case, the container 400 allows a one-time stain treatment.

Alternatively, only the container 400 is disposable. This means that the holder 600 which holds the container 400 can be re-used after another container 400 is placed in the holder 600.

Alternatively, the stain removal accessory 3501 is disposable and designed for a plurality of uses. To this end, the stain removal accessory 3501 contains a container 400 comprising a plurality of sub-compartments. Each sub-compartment holds a container containing stain removing material.

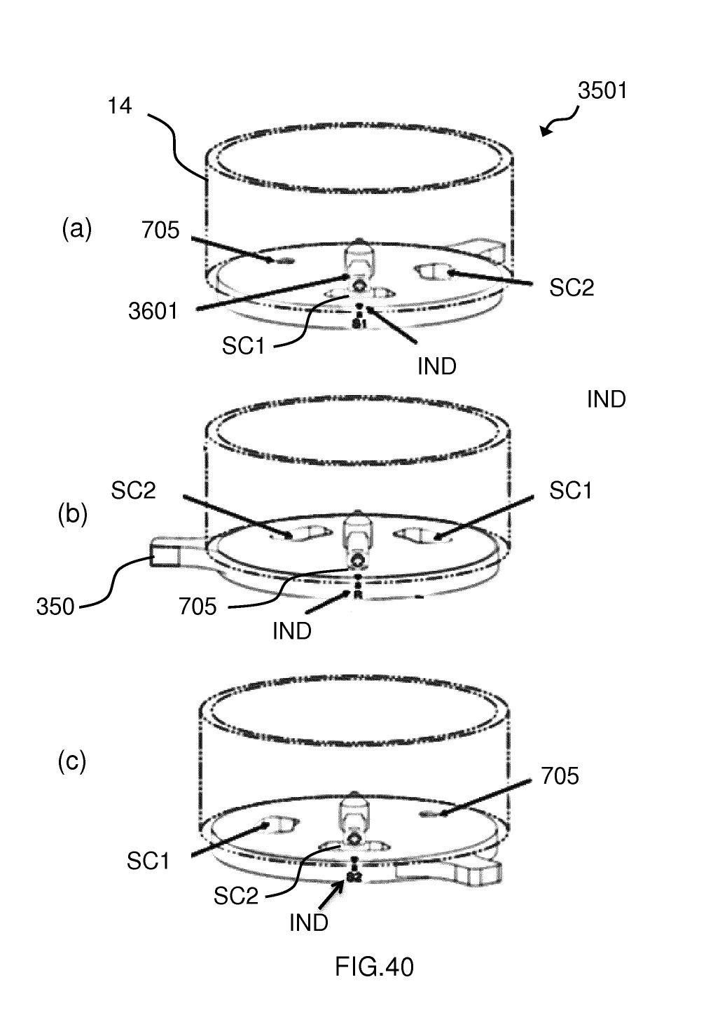

FIG. 40 depicts a stain removal accessory 3501 according to the invention implementing a container comprising a plurality of sub-compartments, each sub-compartment comprising a stain removing material.

The stain removal accessory is represented when cooperating with the front head 14 of the stain removal device (not shown) as described above.

In this example, for sake of simplicity of describing this solution, only two sub-compartments are illustrated:
a first sub-compartment SC1 to hold a first container containing stain removing material,
a second sub-compartment SC2 to hold a second container containing stain removing material.

It is noted that a higher number of sub-compartments could be considered similarly.

In the view (a), the angular position of the stain removal accessory is such that the first container can receive water from the stain removal device in order to dissolve the stain removing material being inside, for a first stain treatment.

In the view (b), the angular position of the stain removal accessory is such that the through hole 705 for rinsing can receive water from the stain removal device in order to rinse the stained area previously treated by the first container. For example, an anticlockwise rotation has been operated compared to the view (a).

In the view (c), the angular position of the stain removal accessory is such that the second container can receive water from the stain removal device in order to dissolve the stain removing material being inside, for a second stain treatment. For example, an anticlockwise rotation has been operated compared to the view (b).

More generally, in case the stain removal accessory is dedicated for successively treating a plurality of stain, a plurality of container, each containing a stain removing material, are switched by moving (for example rotating) the stain removal accessory so that an unused container is positioned under the fluid flow outlet of the device.

To enable a proper alignment for each container with the fluid flow outlet of the device, as well as a proper alignment with the rinsing hole 705, indicators IND may be printed or engraved on both the device head and the stain removal accessory (such as “C1” which stands for “container 1”, “C2” which stands for “container 2”, “R” which stands for “rinsing”).

In addition, the stain removal accessory may include locking studs that lock the stain removal accessory into proper position in the device when the respective pair of indicators on the stain removal accessory and device head are aligned.

Regardless of the number of sub-compartments in a given stain removal accessory (one or more containers), prior to the step of stain removing, in order to prevent the user from rotating the stain removal accessory to a container that has already been used, the bottom rim of each of the chemical sub-compartment may be coated with a paint that permanently changes color after contact with water or the chemical bleach.

FIG. 36 depicts a stain removal accessory according to the invention when cooperating with the front head 14 of a stain removal device, during the step of stain removing.

When the stain removal accessory is positioned in the stain removal device in the step of stain removing, three events occur concurrently:
The capacitive and/or resistive element 3504 comes in contact with a sensor in the stain removal device, and the sensor activates the conductive/inductive heater in the device,
The water-flow switch 3601 in the stain removal device is activated such that a hole of the water-flow switch 3601 is aligned with the container 400. Water from the device can thus flow through the container 400, dissolving the stain removal chemical in order to form a bleach chemical solution. Water-flow switch is activated (for example the spring is compressed and the hole of the water-flow switch 3601 is moved to an activated position) as long as the the stain removal accessory is attached to the stain removal device.
The heat conductive/inductive material of the holder 600 is heated up by a heat generator comprised in the stain removal device. For example, the heat generator corresponds to the heating plate 7.

Therefore, when the stain removal accessory cooperates with the stain removal device in the step of stain removing, chemical solution from the stain removal accessory can be dosed onto the stained area. The chemical solution that has been dosed onto the stained area is heated by the heated holder 600, so that the heated chemical solution can more efficiently remove the stain. Indeed, the water dissolving rate of the bleach chemical increases while the temperature increases. So H₂O₂ or Peroxy acid will be released very fast while in contact with steam 200 or hot water 200.

In other words, heat is used to accelerate the chemical reaction between the chemical solution and the stain (and accelerate the drying after stain treatment). After the step of stain removing is completed, the heated holder 600 can be used to dry the stained area.

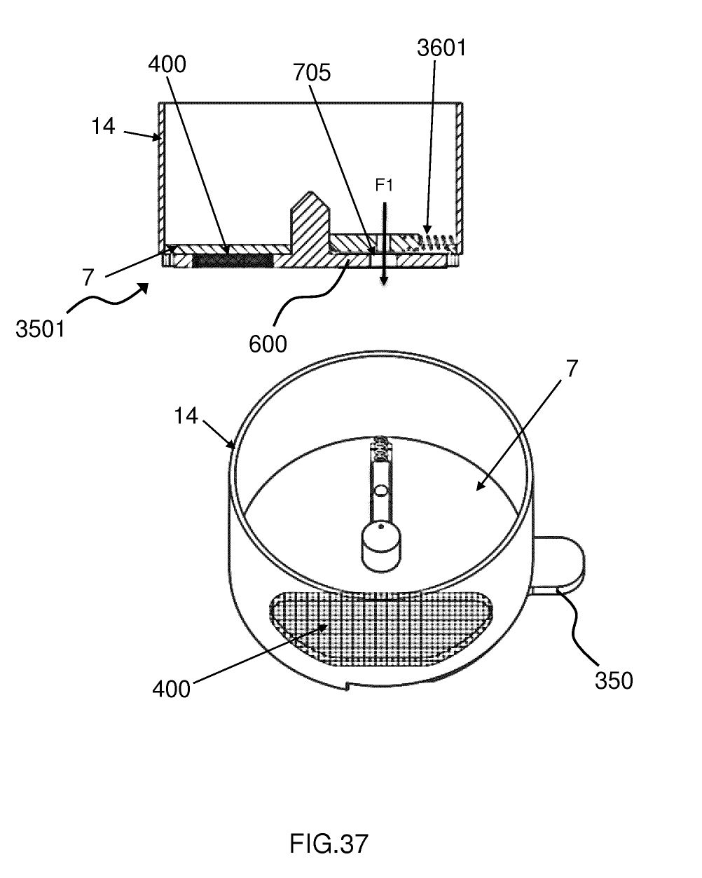

FIG. 37 depicts a stain removal accessory according to the invention when cooperating with the front head 14 of a stain removal device during the step of rinsing the stained area.

When the stain removal accessory is positioned in the stain removal device in the step of rinsing, three events occur concurrently:
The water-flow switch 3601 in the device continues to be activated such that the water-flow hole in the switch 3601 is aligned to the through hole 705 in the stain removal accessory, so that water from the stain removal device can flow through the hole 705 of the stain removal accessory. The water which is dosed can rinse the treatment stain residue out of the garment.
The capacitive and/or resistive element 3504 continues to contact with the sensor in the stain removal device, and the sensor continues to activate the conductive/inductive heater in the stain removal device, which results in heating up the holder 600. The heat which is communicated to the stained area first improves the rinsing efficiency, and secondly, when the flow of rinsing water is stopped, the wet garment can be dried by the heated stain removal accessory. Rinsing duration is dependent on the required quality of rinse.

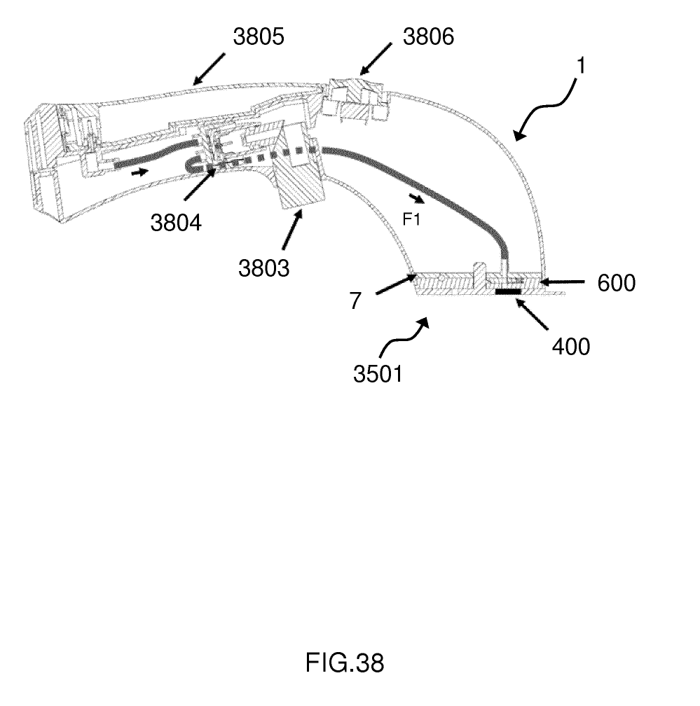

FIG. 38 depicts a stain removal accessory 3501 according to the invention when cooperating with a stain removal device 1 during the step of stain removing.

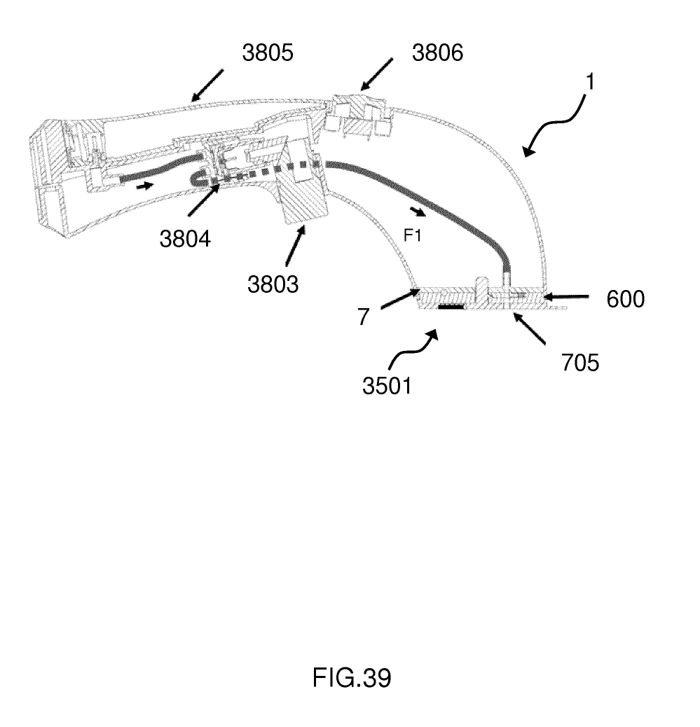

FIG. 39 depicts a stain removal accessory 3501 according to the invention when cooperating with a stain removal device during the step of rinsing (and drying).

The stain removal device 1 comprises:
a heating plate 7 adapted to diffuse heat to the holder 600 of the stain removal accessory 3501.
a (refillable) tank 3805, for example detachable, for holding water used for both bleach chemical dissolution and stain rinsing,
a fluid-dosing system 3804 (such as a pump) and the required tubes, for carrying water from the tank 3805,
a fluid-dosing trigger 3803 to activate the fluid-dosing system 3804,
a temperature switch 3806 (to switch the heating plate 7 from stain removal treatment temperature to drying temperature). Preferably, during the step of drying, the heating plate 7 should have a temperature between 60° C. and 170° C. Optionally, hot air of over 60° C. may also be used for drying.
a water-flow switch 3601 as described above. The flow of fluid may be either bleach chemical solution (a solution of water and dissolved chemical) or rinsing water.
Attaching means to attach the stain removal accessory 3501 (for example a locking stud).

Optionally, the stain removal device further comprises a liquid tank (not shown) for containing chemical neutralizer used during the step of rinsing.

Preferably, the chemical neutralizer is selected among any one of the following:
weak acid-like citric acid and/or sodium citrate;
weak alkaline-like sodium carbonate and/or sodium bicarbonate;
reducing agents.

Depending on the position of the stain removal accessory, the fluid flow path μl can be either a water-chemical hybrid flow path or a water flow path:
When the stain removal accessory is positioned in the step of stain removing, water flows from the water tank to the container 400 of the stain removal accessory, in order to dissolve the stain removal material and form a bleach chemical solution. This situation is illustrated in FIG. 38.
When the stain removal accessory is positioned in the step of rinsing the stained area, water flows from the water tank to the through hole 705 of the stain removal accessory. This situation is illustrated in FIG. 39.

An example of usage of a stain removal accessory according to the invention having only a one-time use container when cooperating with a stain removal device is as follows:
1. Insert central protrusion (physical element) of the stain removal accessory into the corresponding central hole provided in the front head of the stain removal device (as shown in FIG. 36). The physical element on the stain removal accessory slides into a groove and pushes the water-flow switch in the stain removal device to allow the water circuit be opened. Concurrently, the capacitive and/or resistive element 3504 comes in contact with the sensor in the stain removal device. The sensor then activates the conductive/inductive heater in the stain removal device, for example to heat the heating plate 7.
2. The stain removal accessory is turned 90 degrees (clockwise) to reach a position corresponding to the stain removing mode. In this position, the container 400 in the stain removal accessory is in the water pathway, i.e. aligned with the water outlet hole in the stain removal device. The user can thus press the pump trigger so that water flows through the container 400.
3. The holder 600 of the stain removal accessory is heated up by the heater in the stain removal device, for example by the heating plate 7, and allows heat transfer to the stained area.
4. The activation of water flow and heater in the stain removal device, the alignment of the container with the stain removal device water hole, and the transfer of heat to the stained area by the stain removal accessory allow the user to conduct the step of stain removing.
5. After stain removing treatment, the stain removal accessory is turned 180 degree anticlockwise to enter the rinsing/drying mode. In this position, the eccentric circular hole matches the water hole in the stain removal device, allowing water (without chemical) be applied on the treated stained area. It was observed that rinsing duration should be at least 10 seconds with this defined opening size and steam rate. The rinse duration should be at least 3 seconds for such a device 1 of the present invention. The rinsing fluid dosing rate can be between 5 g/min and 150 g/min.
6. In drying mode, a switch on the stain removal device is user activated to increase the heater power to heat the stain removal accessory to a higher temperature for a better drying effect. Optionally, the device enables two temperature settings, which is beneficial for treating different fabric types. For instance, delicate fabrics require lower temperature for drying, while normal fabrics can withstand higher temperatures for faster drying. Alternatively, drying may be achieved through other means of providing heat or air movement, such as hot air, radiation, moving air or vacuum extraction.
7. Finally, the stain removal accessory is turned back 90 degrees clockwise to the centre position to eject the stain removal accessory from the stain removal device.

The stain removal device 1 of the present invention for removing stains on fabrics is portable, and may have a power cord or be cordless.

To this end, power supply for the stain removal device can be connected to household supply while in operation (with power cord) or to an energy accumulator (cordless).

The energy accumulator can be a storage battery or a capacitor based storage (not shown). In this cordless type of implementation, the stain removal device 1 can be charged at home but used at other places like office, restaurant, etc. or can be brought out for traveling.

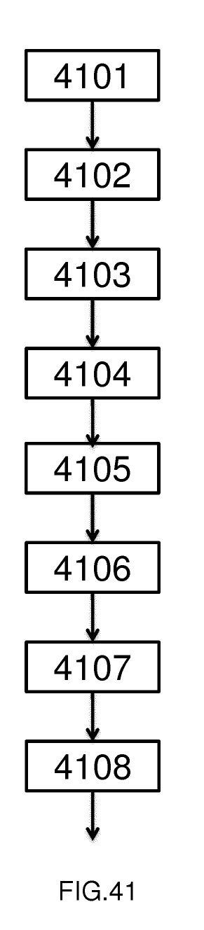

FIG. 41 depicts a flow chart of a method according to the invention of treating a stain on a garment.

The method comprises the steps of:
coupling 4101 a stain removal accessory as previously described to a stain removal device 1 as previously described,
dissolving 4102 with water the stain removing material in the container,
applying 4103 the dissolved stain removing material over the stained area on the garment,
heating 4104 the stained area for a certain duration.

Preferably, the method further comprises the steps of:
positioning 4105 the stain removal accessory to reach a rinsing position,
dosing 4106 a certain amount of water over the stain for rinsing,
heating 4107 the stain for drying.

In case the container of the stain removal accessory comprises a plurality of sub-compartments, the method further comprises a step of:
positioning 4108 the stain removal accessory to reach the position of a sub-compartment in which the stain removing material has not been used for stain treatment before, then the method continues from the step of dissolving 4102.

The above embodiments as described are only illustrative, and not intended to limit the technique approaches of the present invention. Although the present invention is described in details referring to the preferable embodiments, those skilled in the art will understand that the technique approaches of the present invention can be modified or equally displaced without departing from the protective scope of the claims of the present invention. In the claims, the word “comprising” does not exclude other elements or steps, and the indefinite article “a” or “an” does not exclude a plurality. Any reference signs in the claims should not be construed as limiting the scope.

1. A stain removal accessory for use with a stain removal device for treating a stained area, the stain removal accessory comprising:
a container for containing a stain removing material;
a holder for holding the container;
the stain removal accessory being adapted to release said stain removing material on the stained area,
wherein the stain removal accessory defines a flap-flip piece adapted to take a first position during a step of stain removing, and a second position during a step of rinsing the stained area.

2. The stain removal accessory according to claim 1, wherein the holder comprises a frame structure arranged at least partly around the container.

3. (canceled)

4. A stain removal accessory for use with a stain removal device for treating a stained area, the stain removal accessory comprising:
a container for containing a stain removing material;
a holder for holding the container;
a first part for arranging the container containing the stain removing material;
a second part comprising a through hole,
the stain removal accessory being adapted to release said stain removing material on the stained area, and
wherein the stain removal accessory is adapted to take a first position during a step of stain removing, and a second position during a step of rinsing the stained area.

5. The stain removal accessory according to claim 4, wherein the holder is adapted to transfer heat from the stain removal device to the stained area.

6. The stain removal accessory according to claim 4, further comprising a physical element to activate a water-flow switch in the stain removal device in order to open/close a water circuit.

7. The stain removal accessory as claimed in claim 4, further comprising a capacitive element and/or a resistive element that can be detected by the stain removal device to turn-on generation of heat on the stain removal device.

8. The stain removal accessory as claimed in claim 4, wherein the container comprises a plurality of sub-compartments, each sub-compartment comprising a stain removing material.

9. The stain removal accessory according to claim 4, wherein the stain removal accessory is rotatable to take said first position and said second position.

10. The stain removal accessory according to claim 4, wherein the holder comprises a hand grip.

11. A stain removal device comprising a stain removal accessory, the stain removal accessory comprising:
a container for containing a stain removing material;
a holder for holding the container;
the stain removal accessory being adapted to release said stain removing material on the stained area,
wherein the stain removal accessory defines a flap-flip piece adapted to take a first position during a step of stain removing, and a second position during a step of rinsing the stained area.

12. The stain removal device as claimed in claim 11, comprising any one of the following features:
a tank for supplying water to the stain removal accessory for dissolving the stain removing material and/or rinsing the stained area after stain removal,
a sensor to detect that the stain removal accessory is coupled to the stain removal device, to allow a flow of water through the container,
a conductive/inductive heat generator to heat the stain removal accessory, and
a sensor to detect the contact with a capacitive and/or a resistive element of the stain removal accessory, to automatically turn-on the heat generator without user action.

13. The stain removal device as claimed in claim 11, further comprising a liquid tank for containing a chemical neutralizer.

14. A method of treating a stain on a garment by a stain removal accessory and a stain removal device, the method comprising acts of:
coupling the stain removal accessory to the stain removal device, the stain removal accessory including:
a container for containing a stain removing material;
a holder for holding the container;
the stain removal accessory being adapted to release the stain removing material on a stained area;
dissolving with water the stain removing material in the container;
applying the dissolved stain removing material to the stained area on the garment;
heating the stained area for a certain duration; and
rinsing the stained area,
wherein the stain removal accessory defines a flap-flip piece adapted to take a first position during the applying act, and a second position during rinsing act.

15. The method as claimed in claim 14, wherein the rinsing act includes acts of:
positioning the stain removal accessory to reach a rinsing position,
dosing a certain amount of water over the stain for rinsing,
heating the stain for drying.

16. The stain removal accessory according to claim 1, wherein the holder comprises a hand grip.

17. A stain removal device comprising a stain removal accessory, the stain removal accessory comprising:
a container for containing a stain removing material;
a holder for holding the container;
a first part for arranging the container containing the stain removing material;
a second part comprising a through hole,
the stain removal accessory being adapted to release said stain removing material on the stained area, and
wherein the stain removal accessory is adapted to take a first position during a step of stain removing, and a second position during a step of rinsing the stained area.

18. The stain removal accessory according to claim 1, wherein the holder is adapted to transfer heat from the stain removal device to the stained area.

19. The stain removal accessory according to claim 1, further comprising a physical element to activate a water-flow switch in the stain removal device in order to open/close a water circuit.

20. The stain removal accessory as claimed in claim 1, further comprising a capacitive element and/or a resistive element that can be detected by the stain removal device to turn-on generation of heat on the stain removal device.

21. The stain removal accessory as claimed in claim 1, wherein the container comprises a plurality of sub-compartments, each sub-compartment comprising a stain removing material.

22. The stain removal accessory according to claim 1, wherein the stain removal accessory is rotatable to take said first position and said second position.

23. The stain removal accessory according to claim 1, wherein the holder comprises a hand grip.
